(19) United States
(12) Patent Application Publication
(10) Pub. No.: US 2015/0362591 A1
(43) Pub. Date: Dec. 17, 2015

(54) RADAR APPARATUS HAVING TRANSMISSION ANTENNA FOR EMITTING TRANSMISSION SIGNAL FOR DETECTING OBSTACLE

(71) Applicant: MITSUBISHI ELECTRIC CORPORATION, Tokyo (JP)

(72) Inventors: Yoshitsugu SAWA, Chiyoda-ku (JP); Hiroshi ARAKI, Chiyoda-ku (JP); Kenji INOMATA, Chiyoda-ku (JP)

(73) Assignee: MITSUBISHI ELECTRIC CORPORATION, Tokyo (JP)

(21) Appl. No.: 14/763,105

(22) PCT Filed: Aug. 28, 2013
(86) PCT No.: PCT/JP13/73033

§ 371 Date: Jul. 23, 2015

(30) Foreign Application Priority Data
Mar. 19, 2013 (JP) 2013-057051

(51) Int. Cl. G01S 13/58; G01S 13/93; G01S 7/35

(52) U.S. Cl. CPC G01S 13/584; G01S 7/354; G01S 13/931

(57) ABSTRACT

In a radar apparatus having a transmitting antenna that radiates a transmission signal for detecting an obstacle, and a receiving antenna that receives a reflected wave reflected on the obstacle as a reception signal, a beat signal that is a frequency difference between the transmission signal and the reception signal is generated, and presence or absence of the obstacle is detected on the basis of a frequency analysis result of the beat signal. When an obstacle is detected, the relative velocity and the relative distance of the obstacle with respect to the radar apparatus are calculated on the basis of the frequency analysis result of the beat signal, the relative velocity and the relative distance at next measurement of the obstacle with respect to the radar apparatus are estimated, and the transmission signal is controlled so that the beat signal of a large obstacle is eliminated at next measurement on the basis of the estimated relative velocity and relative distance.

### TECHNICAL FIELD

The present invention relates to an FMCW radar apparatus that detects a relative distance and a relative velocity to an obstacle by using a frequency-modulated radio wave as a transmission signal.

### BACKGROUND ART

Conventionally, there has been an FMCW radar apparatus that detects a relative distance and a relative velocity to an obstacle by frequency-modulating a transmission signal and measuring a beat frequency of a frequency difference between the transmission signal and a reception signal reflected from the obstacle. Further, there is an FMCW radar apparatus that adaptively controls a transmission signal. For example, a Patent Literature 1 discloses that frequency-modulated signals of different signal cycles are prepared as a distance surveillance signal and a neighborhood surveillance signal, and the signals are transmitted in a changeover manner, and this leads to that a measurement range is widen and a measurement with high accuracy is performed. In addition, a Patent Literature 2 discloses that the relative velocity is detected with high accuracy by changing the frequency-modulated signal to a CW signal when the distance to a target becomes near and it is judged that collision is unavoidable, and the relative velocity is integrated to perform measurement at a short distance with high accuracy and to measure the relative velocity at the time of collision with high accuracy.

In addition, as means for detecting a small obstacle closing a large obstacle in an FMCW radar apparatus, for example, a Non-Patent Literature 1 discloses a technology called MTI (Moving Target Indicator) that calculates every time a frequency spectrum obtained by subjecting the beat signal of a large obstacle that changes with time to frequency analysis of FFT or the like and eliminates the calculated spectrum to detect the small obstacle.

### CITATION LIST

### Patent Literature

PATENT LITERATURE 1: Japanese Patent Laid-open Publication No. JP2003-222673A
PATENT LITERATURE 2: Japanese Patent No. JP4814261B
NON-PATENT LITERATURE 1: Authored by Matsuo Sekine, “Radar Signal Processing Technology”, Corporation Aggregate of The Institute of Electronics, Information and Communication Engineers, Published in October, 1991

### SUMMARY OF THE INVENTION

### Technical Problem

However, the FMCW radar apparatuses of the Patent Document 1 and the Patent Document 2 have had such a problem that, when detecting a small obstacle closing a large obstacle, the frequency spectrum of the beat signal of the large obstacle has spread to disadvantageously conceal the beat signal of the small obstacle when executing a frequency analysis of FFT or the like, leading to undetectability. In addition, although there is the technology of MTI that detects the small obstacle by estimating the spread frequency spectrum of the large obstacle and removing the component as means for solving this, it has been required to perform calculation of the spectrum of the large obstacle every time, resulting in a very high processing load.

An object of the present invention is to solve the aforementioned problems and provide a radar apparatus capable of detecting a small obstacle closing a large obstacle with a low processing load.

### Solution to Problem

According to a radar apparatus of the present invention, the radar apparatus includes a transmitting antenna that radiates a transmission signal to detect an obstacle, and a receiving antenna that receives a reflected wave reflected on the obstacle as a reception signal. The radar apparatus includes an oscillator configured to generate a transmission signal whose frequency linearly rises or falls with respect to time; a spurious elimination circuit configured to eliminate a frequency component of a predetermined frequency fc; a mixer configured to generate a beat signal of a frequency difference between the transmission signal and the reception signal; object detection means configured to detect presence or absence of an obstacle on the basis of a frequency analysis result of the beat signal; relative velocity and relative distance calculation means configured to calculate a relative velocity and a relative distance of the obstacle with respect to the radar apparatus on the basis of the frequency analysis result of the beat signal when the object detection means detects the obstacle; object selection means configured to select an obstacle on the basis of the relative velocity and the relative distance;

movement prediction means configured to estimate a relative velocity and a relative distance of a selected obstacle with respect to the radar apparatus at next measurement; and control voltage generation means configured to control the transmission signal so that the beat signal of the selected obstacle is eliminated by the spurious elimination circuit at next measurement on the basis of the estimated relative velocity and relative distance.

### Advantageous Effects of the Invention

According to the radar apparatus of the present invention, the transmission signal is controlled so that the beat signal of a large obstacle can be eliminated at next measurement, and therefore, it becomes possible to calculate the relative distance and the relative velocity of a small obstacle closing the large obstacle with a low processing load.

### BRIEF DESCRIPTION OF DRAWINGS

FIG. 1 is a block diagram showing a configuration of a radar apparatus 100 according to a first embodiment of the present invention.

FIG. 2 is a flow chart showing a relative velocity and a relative distance of obstacle calculation process executed by the radar apparatus 100 of FIG. 1.

FIG. 3 is a time axis waveform chart showing a change of a frequency f with respect to time t of a transmission signal TSi generated by an oscillator 1 of FIG. 1.

FIG. 4 is a time axis waveform chart showing a change of a frequency with respect to the time t of a beat signal BS that is a frequency difference between a frequency of the transmission signal TSi of FIG. 3 and the frequency of the reception signal RS as a consequence that the transmission signal TSi is reflected on an obstacle and received by the receiving antenna 3, where an elapsed time axis of FIG. 4 is common to an elapsed time axis of FIG. 3.

FIG. 5 is a spectrum waveform chart showing a change of a spectral intensity P with respect to a frequency f of the beat signal BS of FIG. 4.

FIG. 6 is a spectrum waveform chart showing a relative power P with respect to a frequency f illustrating a frequency characteristic of a spurious elimination circuit 14 of FIG. 1.

FIG. 7 is a time axis waveform chart showing a change of a frequency f with respect to the time t of the transmission signal TSc controlled on the basis of a movement prediction signal PS outputted from a movement prediction circuit 12 of FIG. 1 and a time axis waveform chart showing a change of a frequency f with respect to the time t of the reception signal RS as a consequence that the controlled transmission signal TSc is reflected on the obstacle and received by the receiving antenna 3 of FIG. 1.

FIG. 8 is a time axis waveform chart showing a change of a frequency with respect to the time t of the beat signal BS that is a frequency difference between the frequency of the controlled transmission signal TSc of FIG. 7 and the frequency of the reception signal RS as a consequence that the transmission signal TSc is reflected on an obstacle and received by the receiving antenna 3, where an elapsed time axis of FIG. 8 is common to that of FIG. 7.

FIG. 9 is a spectrum waveform chart showing a change of a spectral intensity P with respect to the frequency f of the beat signal BS of FIG. 8.

FIG. 10 is a block diagram showing a configuration of the movement prediction circuit 12 of the radar apparatus 100 of FIG. 1 according to a second embodiment of the present invention.

FIG. 11 is a block diagram showing a configuration of a radar apparatus 100A according to a third embodiment of the present invention.

FIG. 12 is a block diagram showing a configuration of a movement prediction circuit 12A of the radar apparatus 100A of FIG. 11.

FIG. 13 is a flow chart showing a relative velocity and a relative distance of an obstacle calculation process executed by the radar apparatus 100A of FIG. 11.

### DESCRIPTION OF EMBODIMENTS

Embodiments of the present invention will be described below with reference to the drawings. In the following embodiments, like components are denoted by like reference numerals, and no description is provided for them.

### First Embodiment

According to a radar apparatus 100 of a first embodiment of the present invention, a beat signal BSl based on a reception signal RSl from a large obstacle can be eliminated by controlling a transmission signal TS, and therefore, a relative velocity and a relative distance of a small obstacle closing a large obstacle with respect to the radar apparatus 100 can be calculated. It will be described below in detail.

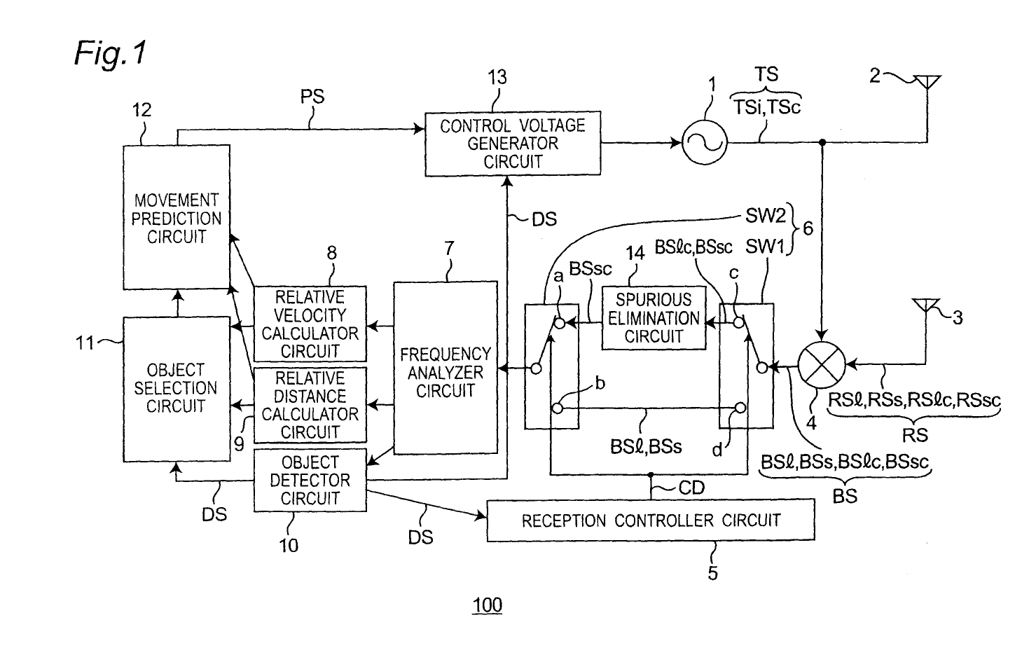

FIG. 1 is a block diagram showing a configuration of the radar apparatus 100 according to the first embodiment of the present invention. The radar apparatus 100 of FIG. 1 is configured to include a control voltage generator circuit 13 that generates a control voltage for generating an arbitrary frequency-modulated wave; an oscillator 1 whose frequency changes according to the control voltage generated by the control voltage generator circuit 13; a transmitting antenna 2 that radiates the transmission signal TS generated by the oscillator 1 as a transmission wave; a receiving antenna 3 that receives each reflected wave reflected on an obstacle as a reception signal RS; a mixer 4 that generates a beat signal BS, which is a frequency difference between the transmission signal TS and the reception signal RS; a frequency analyzer circuit 7 that executes frequency analysis by FFT processing of the beat signal BS; a relative velocity calculator circuit 8 that is relative velocity calculation means for calculating a relative velocity of the obstacle with respect to the radar apparatus 100; a relative distance calculator circuit 9 that is relative distance calculation means for calculating the relative distance of the obstacle with respect to the radar apparatus 100; an object detector circuit 10 that is object detection means for detecting presence or absence of the objective obstacle; an object selection circuit 11 that is object selection means for selecting an object to be eliminated; a movement prediction circuit 12 that is movement prediction means for estimating a relative distance and a relative velocity of the obstacle selected by the object selection circuit 11; a spurious elimination circuit 14 that executes a filtering process to remove a frequency component of a predetermined frequency fc; a switching circuit 6 for turning on and off the spurious elimination circuit 14; and a reception controller circuit 5 that controls the switching circuit 6.

The oscillator 1 of FIG. 1 generates a transmission signal TS having a frequency corresponding to the control voltage generated by the control voltage generator circuit 13, and outputs a generated transmission signal TS to the transmitting antenna 2 and the mixer 4. In addition, the transmitting antenna 2 radiates the transmission signal TS for detecting an obstacle as a transmission wave to a space around the radar apparatus 100. Further, the receiving antenna 3 receives a reflected wave reflected on the obstacle as a reception signal RS, and outputs a received reception signal RS to the mixer 4. Further, the mixer 4 multiplies the transmission signal TS generated by the oscillator 1 by the reception signal RS received by the receiving antenna 3, and outputs a signal of multiplication results as a beat signal BS to the frequency analyzer circuit 7 or the spurious elimination circuit 14. In this case, the mixer 4 has a function to remove higher harmonic components from the signal of the multiplication results of the transmission signal TS and the reception signal RS by filtering the same higher harmonic components.

The frequency analyzer circuit 7 of FIG. 1 receives an input of the beat signal BS outputted from the mixer 4, executes the FFT processing to analyze the frequency spectrum of the beat signal BS, and outputs a frequency analysis result to the relative velocity calculator circuit 8, the relative distance calculator circuit 9, and the object detector circuit 10, respectively. In addition, the relative velocity calculator circuit 8 calculates a relative velocity of the obstacle with respect to the radar apparatus 100 on the basis of the frequency analysis result of the beat signal BS by the frequency analyzer circuit 7, and outputs data of a calculated relative velocity, to the object selection circuit 11 and the movement prediction circuit 12. Further, the relative distance calculator circuit 9 calculates a relative distance of the obstacle with respect to the radar apparatus 100 on the basis of the frequency analysis result of the beat signal BS by the frequency analyzer circuit 7, and outputs data of the calculated relative distance to the object selection circuit 11 and the movement prediction circuit 12.

The object detector circuit 10 of FIG. 1 detects presence or absence of the objective obstacle on the basis of the frequency analysis result of the beat signal BS by the frequency analyzer circuit 7, generates an obstacle detection signal DS when the objective obstacle is detected, and outputs an obstacle detection signal DS to the object selection circuit 11, the control voltage generator circuit 13 and the reception controller circuit 5. In this case, when the objective obstacle is detected, the object detector circuit 10 instructs the reception controller circuit 5 to turn on the spurious elimination circuit 14.

The reception controller circuit 5 of FIG. 1 generates a changeover signal CD to turn on or off the spurious elimination circuit 14, and outputs the changeover signal CD to the switches SW1 and SW2 of the switching circuit 6. In this case, when the obstacle detection signal DS that represents detection of the object is received from the object detector circuit 10, a changeover signal CD to turn on the spurious elimination circuit 14 is generated to change the switch SW1 over to a contact point “c” and change the switch SW2 over to a contact point “a”, and this state is maintained until the beat signal BS at next measurement passes through the spurious elimination circuit 14. When the obstacle detection signal DS is not received from the object detector circuit 10, a changeover signal CD to turn off the spurious elimination circuit 14 is generated to change the switch SW1 over to a contact point “d” and change the switch SW2 over to a contact point “b”.

When receiving the obstacle detection signal DS from the object detector circuit 10, the object selection circuit 11 of FIG. 1 selects an obstacle that satisfies a preset condition on the basis of the relative velocity data from the relative velocity calculator circuit 9 and the relative distance data from the relative distance calculator circuit 10, and transmits the result to the movement prediction circuit 12. For example, it is acceptable to select the obstacle when a number of the detected obstacle is one, or to select the obstacle of which the spectral intensity becomes the highest among the frequency spectrums of those beat signals when a plurality of obstacles are detected. In addition, it is acceptable to select the obstacle located the nearest from the radar apparatus 100 on the basis of the relative distance data or to select the obstacle of which the relative velocity with respect to the radar apparatus 100 is the fastest on the basis of the relative velocity data. Further, it is acceptable to select the obstacle that comes the nearest to the radar apparatus 100 at next measurement on the basis of these relative velocity data and relative distance data.

When receiving the result of the selection of an obstacle, the movement prediction circuit 12 of FIG. 1 estimates the relative velocity and the relative distance at next measurement of the selected obstacle with respect to the radar apparatus 100 on the basis of the relative velocity data and the relative distance data, generates a movement prediction signal PS that controls the transmission signal TS so that the beat signal BSl of a large obstacle is eliminated, and outputs the movement prediction signal PS to the control voltage generator circuit 13.

When receiving the obstacle detection signal DS representing the detection of the obstacle from the object detector circuit 10, the control voltage generator circuit 13 of FIG. 1 receives the movement prediction signal PS from the movement prediction circuit 12, and controls the transmission signal TS so that the frequency of the beat signal BSl of the large obstacle becomes a frequency fc. In this case, the control voltage generator circuit 13 is control voltage generation means for controlling the transmission signal TS so that the beat signal of the selected obstacle at next measurement of the radar apparatus 100 is eliminated by the spurious elimination circuit 14. For example, when receiving the obstacle detection signal DS, the control voltage generator circuit 13 becomes able to receive an input of the movement prediction signal PS from the movement prediction circuit 12 as a consequence that a signal line connecting the movement prediction circuit 12 with the control voltage generator circuit 13 enters an enabled state.

The operation of the radar apparatus 100 as configured above is described below.

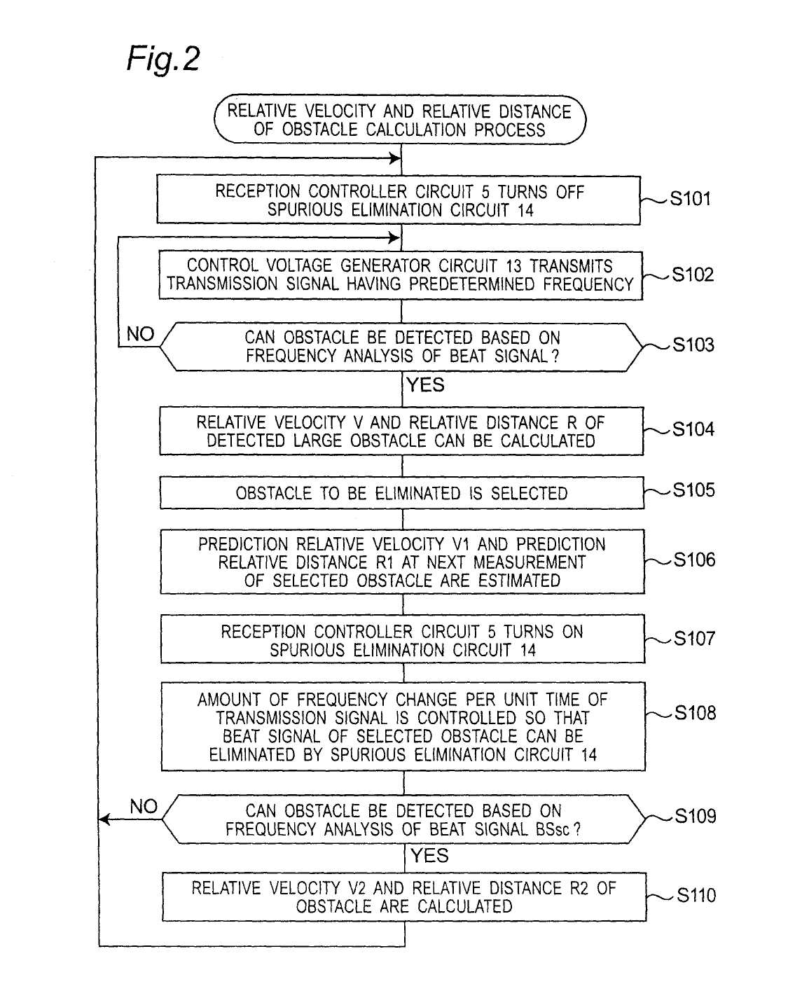

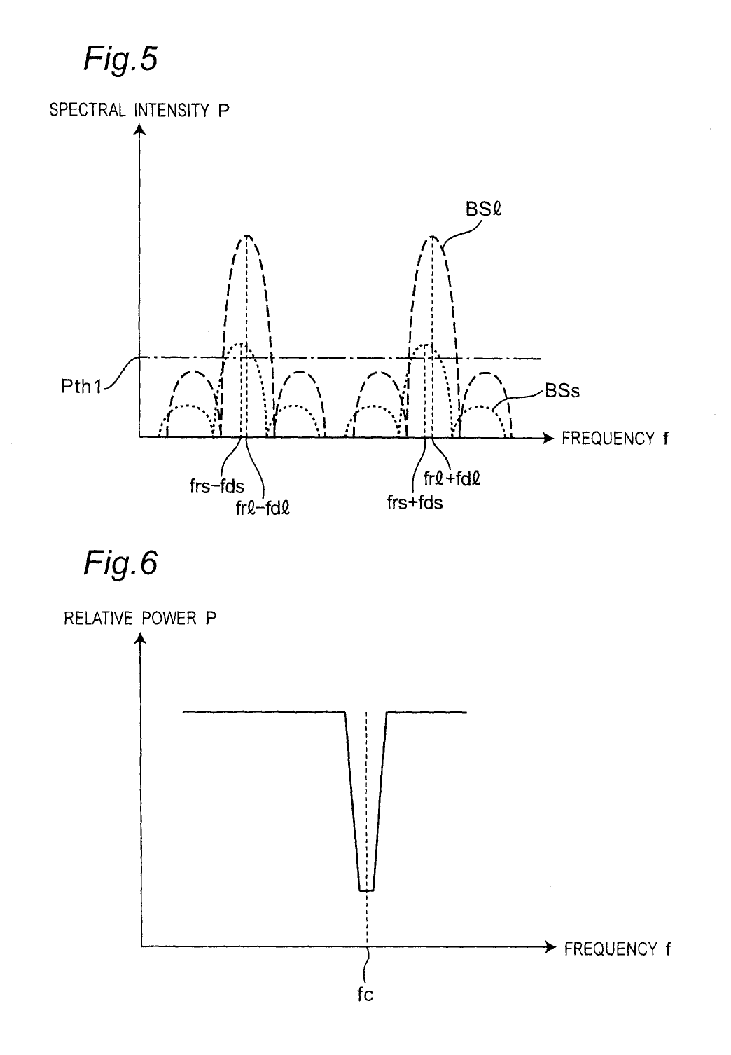

FIG. 2 is a flow chart showing the relative velocity and relative distance of the obstacle calculation process executed by the radar apparatus 100 of FIG. 1. Referring to FIG. 2, when the relative velocity and relative distance of obstacle calculation process is started, the spurious elimination circuit 14 is turned off on the basis of the changeover signal CD from the reception controller circuit 5 (step S101). That is, both the beat signal BSl of a large obstacle and the beat signal BSs of a small obstacle outputted from the mixer 4 are subjected to frequency analysis by the frequency analyzer circuit 7. Next, in step S102, a transmission wave having a predetermined frequency corresponding to the control voltage of the control voltage generator circuit 13 is radiated from the transmitting antenna 2 to search for an obstacle. Next, the frequency spectrum is calculated by performing FFT (Fast Fourier Transform) processing of the beat signal BS from the mixer 4 by the frequency analyzer circuit 8, and the obstacle is detected from the peak frequency that is the projecting portion of the frequency spectrum (step S103). In step S103, a program flow proceeds to next step S104 when an obstacle is detected or returns to step S102 when no obstacle is detected to continuously search for an obstacle. It is noted that, at the time point of step S103, as illustrated in FIG. 5, since it is possible to only achieve resolution at a resolving power of fs/N depending on the sampling frequency fs and the number N of samples because of the characteristic of FFT processing mainly used as the frequency analyzer circuit 7, and the processing is on the assumption that the sampling intervals have continuous waveforms, higher harmonic waves are disadvantageously generated. Therefore, the spectrum waveform of the beat signal BSs of a small obstacle closing a large obstacle cannot be detected.

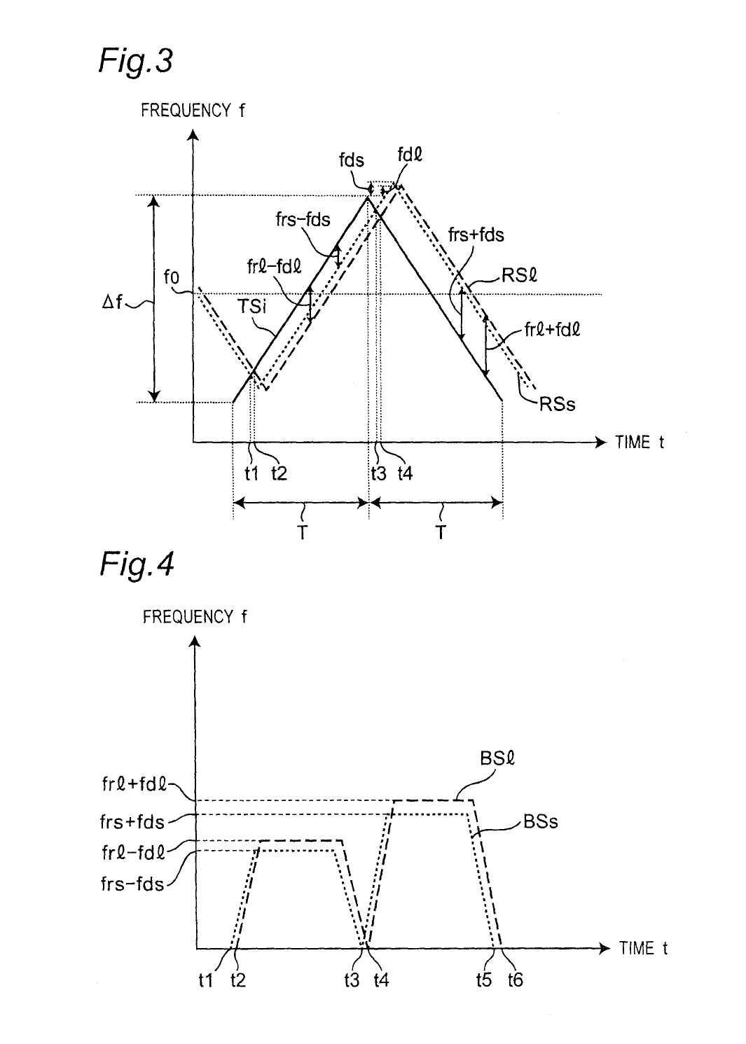

FIG. 3 is a time axis waveform chart showing a change of a frequency f with respect to the time t of a transmission signal TSi generated by the oscillator 1 of FIG. 1. FIG. 3 is a time axis waveform chart showing a change of a frequency f with respect to the time t of a reception signal RS as a consequence that the transmission signal TSi is reflected on an obstacle and received by the receiving antenna 3 of FIG. 1. In FIG. 3, the oscillator 1 generates a transmission signal of which the frequency f linearly rises or falls with respect to the time t. That is, the transmission signal TSi illustrated by the solid lines is transmitted so that an upchirp time interval T during which the frequency rises and a downchirp time interval T during which the frequency falls to a predetermined frequency after rise to a predetermined frequency exist and have an even triangular waveform. In this case, time corresponding to one cycle of the transmission signal TSi is a transmission duration time 2T. In addition, a reception signal RSl as a consequence that the transmission signal TSi is reflected on a large obstacle and a reception signal RSs as a consequence that the signal is reflected on a small obstacle are illustrated by respective dashed lines. Further, regarding the reception signals RSl and RSs, an upchirp time interval and a downchirp time interval also exist similarly to the transmission signal TSi.

A relation between the “large obstacle” and the “small obstacle” is described here. The frequency spectrum of the beat signal BSl that is the frequency difference between the transmission signal TSi and the reception signal RSl of the large obstacle, and the frequency spectrum of the beat signal BSs that is the frequency difference between the transmission signal TSi and the reception signals RSs of the small obstacle are included. For example, in a case where a car B runs ahead of a car A on which the radar apparatus 100 is mounted, the car B corresponds to the “large obstacle”. In a case where a motorcycle runs adjacent to the car B, the motorcycle corresponds to the “small obstacle”.

FIG. 4 is a time axis waveform chart showing a change of a frequency with respect to the time t of the beat signal BS that is the frequency difference between the frequency of the transmission signal TSi of FIG. 3 and the frequency of the reception signal RS as a consequence that the transmission signal TSi is reflected on an obstacle and received by the receiving antenna 3, the elapsed time axis being common to the elapsed time axis of FIG. 3. In FIG. 3, the frequency difference between the transmission signal TSi and the reception signal RSl during the upchirp time interval of the transmission signal TS is a peak frequency (frl−fdl) of the beat signal BSl, and the frequency difference between the transmission signal TSi and the reception signal RSs during the upchirp time interval of the transmission signal TS is a peak frequency (frs−fds) of the beat signal BSs. In addition, the frequency difference between the transmission signal TSi and the reception signal RSl during the downchirp time interval of the transmission signal TS is a peak frequency (frl+fdl) of the beat signal BSl, and the frequency difference between the transmission signal TSi and the reception signal RSs during the downchirp time interval of the transmission signal TS is a peak frequency (frs+fds) of the beat signal BSs.

In FIGS. 3 and 4, each of the delays of the reception signals RSl and RSs from the transmission signal TSi on the time axis of the triangular wave corresponds to time from the reflection on the obstacle of the transmission wave radiated from the transmitting antenna 2 to the reception of the reflected wave by the receiving antenna 3. In addition, deviations of the reception signals RSl and RSs from the transmission signal TSi on the frequency axis are Doppler frequencies fdl and fds, respectively. That is, on the basis of the delays on the time axis and the Doppler frequencies fdl and fds, the frequencies of the beat signals BSl and BSs during the upchirp time interval and the frequencies of the beat signals BSl and BSs during the downchirp time interval change. Therefore, by detecting these frequencies, the relative distance R of the obstacle with respect to the radar apparatus 100 and the relative velocity V of the obstacle with respect to the radar apparatus 100 can be calculated (step S104 of FIG. 2 described later). In this case, the distance delay component frl based on the relative distance R of the obstacle with respect to the radar apparatus 100 and the Doppler frequency component fdl based on the relative velocity V of the obstacle with respect to the radar apparatus 100 regarding the beat signal BSl of the large obstacle can be calculated by the sum and the difference of the peak frequency (frl+fdl) and the peak frequency (frl−fdl) of the beat signal BSl of FIG. 4. Likewise, the distance delay component frs based on the relative distance R of the obstacle with respect to the radar apparatus 100 and the Doppler frequency component fds based on the relative velocity V of the obstacle with respect to the radar apparatus 100 regarding the beat signal BSs of the small obstacle can be calculated by the sum and the difference of the peak frequency (frs+fds) and the peak frequency (frs−fds) of the beat signal BSs of FIG. 4.

In general, regarding the distance delay component fr contained in the beat signal BS, the relational expression of the following equation holds:

$$fr = \frac{2 Δ fR}{C} , \qquad ( 1 )$$

where Δf is an amount of frequency change per unit time, R is a relative distance of the obstacle with respect to the radar apparatus 100, and C is a velocity of light.

In addition, regarding the Doppler frequency component fd contained in the beat signal BS, the relational expression of the following equation holds:

$$fd = \frac{2 {Vf}_{0}}{C} , \qquad ( 2 )$$

where V is a relative velocity of the obstacle with respect to the radar apparatus 100, f₀ is a center frequency of the transmission signal TSi, and C is a velocity of light.

FIG. 5 is a spectrum waveform chart showing a change of a spectral intensity P with respect to the frequency f of the beat signal BS of FIG. 4. In FIG. 5, the spectral intensity P of the spectrum waveform of the beat signal BSl of a large obstacle and the spectral intensity P of the spectrum waveform of the beat signal BSs of a small obstacle are each larger than or equal to a predetermined threshold value Pth1, and therefore, both the beat signals BSl and BSs are detected. In this case, the spectral intensity P of the beat signal BSl of the large obstacle is larger than the spectral intensity P of the beat signal BSs of the small obstacle, and spectrums corresponding to the beat frequencies are observed.

In step S104 of FIG. 2, the relative velocity V and the relative distance R of the detected obstacle are calculated. In this case, the relative velocity calculator circuit 8 calculates a difference ((frl+fdl)−(frl−fdl))=2fdl of the peak frequency of the frequency spectrum outputted from the frequency analyzer circuit 7, extracts the Doppler frequency component depending on the relative velocity V, and calculates the relative velocity V by substituting it for the following equation:

$$V = \frac{Cfdl}{2 {f}_{0}} , \qquad ( 3 )$$

where fdl is a Doppler frequency component contained in the beat signal BSl of the large obstacle, f₀ is a center frequency of the transmission signal TSi, and C is a velocity of light.

In addition, the relative distance calculator circuit 9 calculates a difference ((frl+fdl)+(frl−fdl))=2frl of the peak frequency of the frequency spectrum outputted from the frequency analyzer circuit 7, extracts the distance delay component depending on the relative distance R, and calculates the relative distance R by substituting it for the following equation:

$$R = \frac{2 Δ f}{frlC} , \qquad ( 4 )$$

where frl is a distance delay component contained in the beat signal BSl of the large obstacle, Δf is an amount of frequency change per unit time, and C is a velocity of light.

In FIG. 2, the object selection circuit 11 selects the obstacle to be eliminated (step S105).

In step S106 of FIG. 2, a prediction relative velocity V1 and a prediction relative distance R1 at next measurement of selected obstacle are estimated from the relative velocity V and the relative distance R of the obstacle selected in step S105. In this case, assuming that the relative velocity V calculated in step 104 will continue until the next measurement, the prediction relative distance R1 at next measurement of the selected obstacle is calculated according to the following equation:

R1=R+VΔt (5),

where R is a relative distance of the selected obstacle with respect to the radar apparatus 100, Δt is a measurement interval of the radar apparatus 100, and V is a relative velocity of the selected obstacle with respect to the radar apparatus 100.

When the obstacle is detected by the object detector circuit 10 in step S107 of FIG. 2, the spurious elimination circuit 14 is turned on so that the reception signal RS passes through the spurious elimination circuit 14 at next measurement. That is, only the beat signal BSs of the small obstacle is outputted to the frequency analyzer circuit 7 between the beat signal BSl of the large obstacle and the beat signal BSs of the small obstacle outputted from the mixer 4.

FIG. 6 is a spectrum waveform chart showing a relative power P with respect to the frequency f illustrating a frequency characteristic of the spurious elimination circuit 14 of FIG. 1. In FIG. 6, the relative power P is largely lowered at the frequency fc. Therefore, the spurious elimination circuit 14 has a function to eliminate the signal of the frequency fc.

In step S108 of FIG. 2, the amount of frequency change Δfc per unit time of the transmission signal TSc is controlled according to the following equation so that the beat signal BSl of the selected obstacle is eliminated on the basis of the prediction relative distance R1 and the prediction relative velocity V1 at next measurement of the selected obstacle estimated in step S106:

$$Δ fc = \frac{{Cf}_{c} \pm 2 V 1 {f}_{1}}{2 R 1} , \qquad ( 6 )$$

where Δf is an amount of frequency change per unit time of the controlled transmission signal TSc, C is a velocity of light, fc is a frequency to be eliminated by the spurious elimination circuit 14, V1 is a relative velocity at next measurement of the selected obstacle, R1 is a relative distance at next measurement of the selected obstacle, and f1 is a center frequency of the transmission signal TSc.

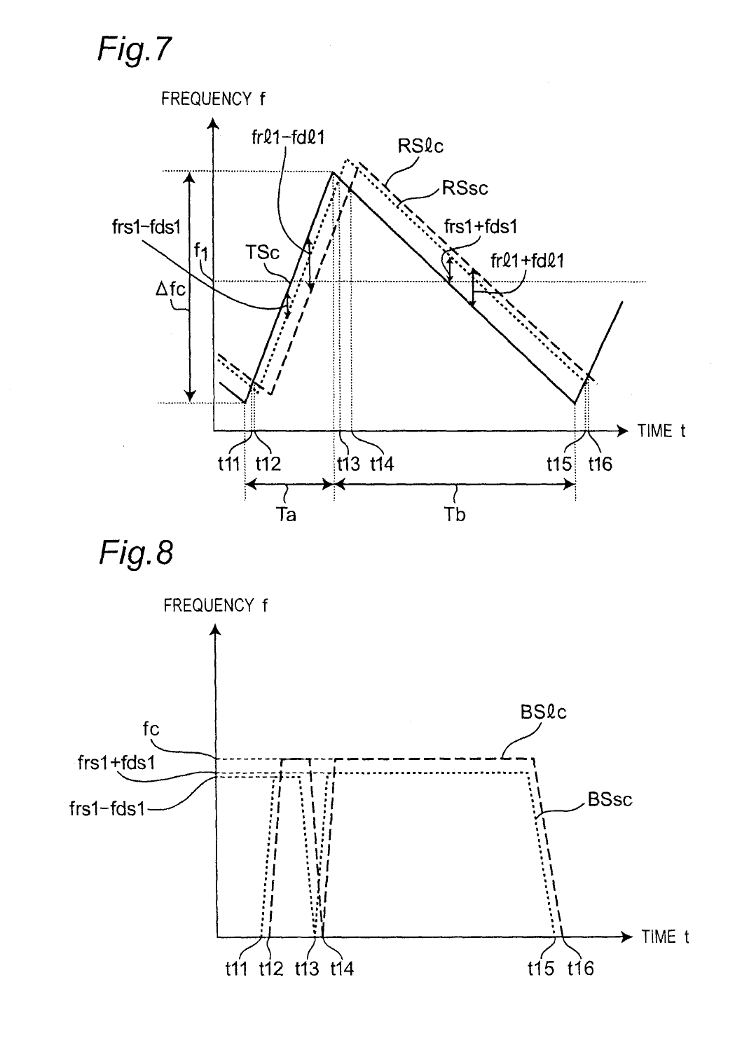

Further, a detection distance from the radar apparatus 100 to the obstacle can be secured by controlling the transmission duration time (Ta+Tb) of the transmission signal TSc of FIG. 7 to be larger than or equal to (2×R1/C) (C is a velocity of light, and R1 is a relative distance at next measurement of the selected obstacle). It is noted that the transmission duration time (Ta+Tb) is described later.

FIG. 7 is a time axis waveform chart showing a change of a frequency f with respect to the time t of the transmission signal TSc controlled on the basis of the movement prediction signal PS outputted from the movement prediction circuit 12 of FIG. 1 and a time axis waveform chart showing a change of a frequency f with respect to the time t of the reception signal RS as a consequence that the controlled transmission signal TSc is reflected on the obstacle and received by the receiving antenna 3 of FIG. 1. In FIG. 7, in the transmission signal TSc illustrated by the solid lines, an upchirp time interval Ta during which the frequency rises and a downchirp time interval Tb during which the frequency falls to a predetermined frequency after rise to a predetermined frequency exist. In this case, the time interval corresponding to one cycle of the controlled transmission signal TSc is the transmission duration time (Ta+Tb). In addition, a reception signal RSlc as a consequence that the controlled transmission signal TSc is reflected on a large obstacle and received and a reception signal RSsc as a consequence that the controlled transmission signal TSc is reflected on a small obstacle and received are illustrated by respective dashed lines. Further, the reception signals RSlc and RSsc also have an upchirp time interval and a downchirp time interval similarly to the transmission signal TSc.

FIG. 8 is a time axis waveform chart showing a change of a frequency with respect to the time t of the beat signal BS that is a frequency difference between the frequency of the controlled transmission signal TSc of FIG. 7 and the frequency of the reception signal RS as a consequence that the transmission signal TSc is reflected on an obstacle and received by the receiving antenna 3, the elapsed time axis being common to FIG. 7. In this case, the reflected wave reflected on a large obstacle is a reception signal RSl, and the reflected wave reflected on a small obstacle is a reception signal RSs. Referring to FIG. 8, a frequency difference between the transmission signal TSc and a reception signal RSlc during the upchirp time interval of the transmission signal TSc is the peak frequency (frl1−fdl1) of a beat signal BSlc, and a frequency difference between the transmission signal TSc and the reception signal RSsc during the upchirp time interval of the transmission signal TS is the peak frequency (frs1−fds1) of a beat signal BSsc. In addition, a frequency difference between the transmission signal TSc and a reception signal RSlc during the downchirp time interval of the controlled transmission signal TSc is the peak frequency (frl1+fdl1) of a beat signal BSlc, and a frequency difference between the transmission signal TSc and a reception signal RSsc during the downchirp time interval of the controlled transmission signal TSc is the peak frequency (frs1+fds1) of a beat signal BSsc.

In step S109 of FIG. 2, the beat signal BSlc of the large obstacle among the beat signal BSlc of the large obstacle and the beat signals BSsc of the small obstacle outputted from the mixer 4 is eliminated by the spurious elimination circuit 14, and only the beat signal BSsc of the small obstacle is subjected to a frequency analysis by the frequency analyzer circuit 7. The program flow moves to step S101 if it is judged that the small obstacle has been detected when a spectral intensity, which is larger than or equal to a predetermined threshold value, is detected or the program flow returns to step S110 when it is not detected.

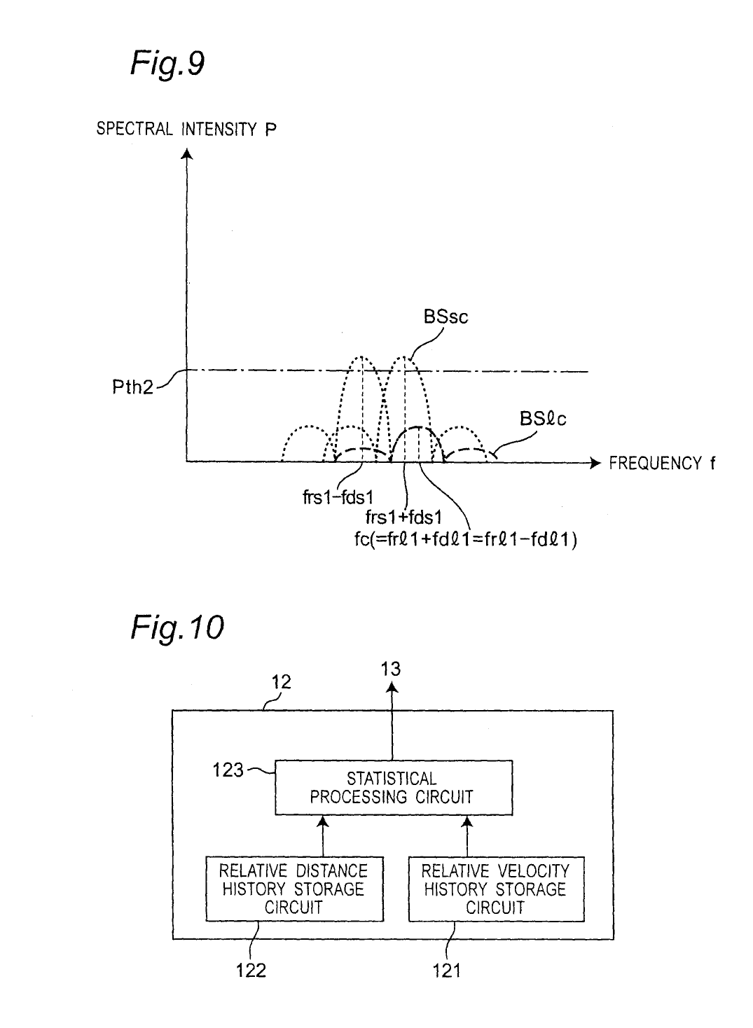

FIG. 9 is a spectrum waveform chart showing a change of a spectral intensity P with respect to the frequency f of the beat signal BS of FIG. 8. Referring to FIG. 9, the beat signal BSlc of the large obstacle is eliminated by the spurious elimination circuit 14 of FIG. 1, and only the beat signal BSsc of the small obstacle is transmitted to the frequency analyzer circuit 7. In this case, the spectral intensity P of the spectrum waveform of the beat signal BSlc of the large obstacle becomes lowered than the spectral intensity P of the spectrum waveform of the beat signal BSsc of the small obstacle, and therefore, only the beat signal BSsc of the small obstacle is detected when the spectrum waveform having the spectral intensity, which is larger than or equal to a predetermined threshold value Pth2, is detected.

In step S110 of FIG. 2, the relative velocity V2 and the relative distance R2 of the small obstacle are calculated on the basis of the frequency analysis result of the beat signal BSsc of the small obstacle outputted from the mixer 4 as in step S104. In this case, the relative distance R2 and the relative velocity V2 are calculated according to the following equation:

$$R 2 = \frac{R 1 ( ( frs 1 + fds 1 ) + ( frs 1 - fds 1 ) )}{2 fc} , \qquad ( 7 )$$

where R1 is a prediction relative distance at next measurement of the selected obstacle, fc is a frequency to be eliminated by the spurious elimination circuit 14, (frs1+fds1) is a frequency difference between the transmission signal TSc and the reception signal RSsc during the upchirp time interval of the transmission signal TS, and (frs1−fds1) is a frequency difference between the transmission signal TSc and the reception signal RSsc during the upchirp time interval of the transmission signal TS:

$$V 2 = \frac{( ( frs 1 + fds 1 ) - ( frs 1 - fds 1 ) ) C}{4 {f}_{1}} - \frac{( ( frs 1 + fds 1 ) + ( frs 1 - fds 1 ) ) V 1}{2 fc} , \qquad ( 8 )$$

where f₁ is a center frequency of the transmission signal TSc, fc is a frequency eliminated by the spurious elimination circuit 14, V1 is a prediction relative velocity at next measurement of the selected obstacle, (frs1+fds1) is a frequency difference between the transmission signal TSc and the reception signal RSsc during the upchirp time interval of the transmission signal TS, and (frs1−fds1) is a frequency difference between the transmission signal TSc and the reception signal RSsc during the upchirp time interval of the transmission signal TS.

Next, when the relative velocity V2 and the relative distance R2 of the small obstacle are calculated in step S110 of FIG. 2, the program flow returns to step S101 to repeat the aforementioned processes of step S101 to step S109.

According to the radar apparatus 100 of the above embodiment, the transmission signal TS can be controlled so that the beat signal of the large obstacle is eliminated at next measurement of the selected large obstacle. Therefore, it becomes possible to calculate the relative velocity and the relative distance of the small obstacle with respect to the radar apparatus 100 on the basis of the spectrum waveform of the beat signal of the small obstacle closing the large obstacle.

### Second Embodiment

FIG. 10 is a block diagram showing a configuration of the movement prediction circuit 12 of the radar apparatus 100 of FIG. 1 according to a second embodiment of the present invention. The movement prediction circuit 12 of FIG. 10 is characterized in that a relative distance history storage circuit 122 that stores past relative distances, a relative velocity history storage circuit 121 that stores past relative velocities, and a statistical processing circuit 123 that predicts the movement by using the past histories. The means for predicting the movement of the selected obstacle by using information of past relative distances and the relative velocities include, for example, a statistical processing method using a Kalman filter.

The statistical processing circuit 123 of FIG. 10 estimates the relative position and the relative distance of the obstacle at next measurement on the basis of the past relative distance data and the past relative velocity data, generates a movement prediction signal PS for controlling the transmission signal TS so that the frequency of the beat signal BS from the objective obstacle becomes a frequency fc, and outputs the movement prediction signal PS to the control voltage generator circuit 13.

According to the radar apparatus 100 of the present embodiment, as compared with the radar apparatus 100 of the first embodiment, the relative position and the relative velocity of the obstacle at next measurement can be more accurately detected, and the beat signal of the obstacle desired to be eliminated at next measurement can be accurately grasped. Therefore, the range of the frequency eliminated in the spurious elimination circuit 14 can be made to be narrower, and the small obstacle closing the large obstacle can consequently be also detected.

### Third Embodiment

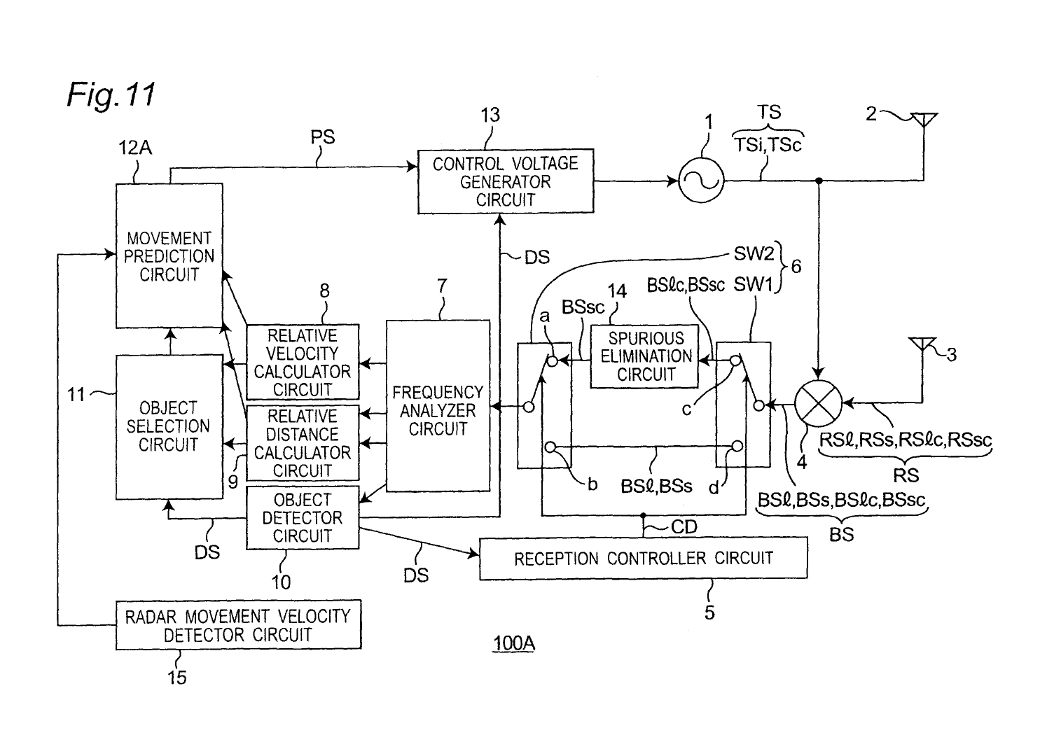

FIG. 11 is a block diagram showing a configuration of a radar apparatus 100A according to a third embodiment of the present invention. As compared with the radar apparatus 100 of FIG. 1, the radar apparatus 100A of FIG. 11 is characterized in that a movement prediction circuit 12A is provided in place of the movement prediction circuit 12, and a radar movement velocity detector circuit 15 is provided in the precedent stage of the movement prediction circuit 12A.

The radar movement velocity detector circuit 15 detects a movement velocity of the radar apparatus 100A, and outputs data of the movement velocity of the detected radar apparatus 100A to the movement prediction circuit 12A. Although the method for detecting the movement velocity of the radar apparatus 100A includes, for example, a detection method by means of an acceleration sensor and a method for obtaining a vehicle speed pulse by means of a vehicle onboard radar, the invention is not limited thereto.

When the information of the obstacle selected from the object selection circuit 11 is obtained, the movement prediction circuit 12A of FIG. 11 estimates the relative distance and the relative velocity at next measurement of the selected obstacle on the basis of the movement velocity data of the radar apparatus 100A from the radar movement velocity detector circuit 15, the relative velocity data of the selected obstacle, and the relative distance data of the selected obstacle, generates a movement prediction signal PS for controlling the transmission signal TS so that the frequency of the beat signal of the selected obstacle at next measurement becomes the frequency fc, and outputs the movement prediction signal PS to the control voltage generator circuit 13.

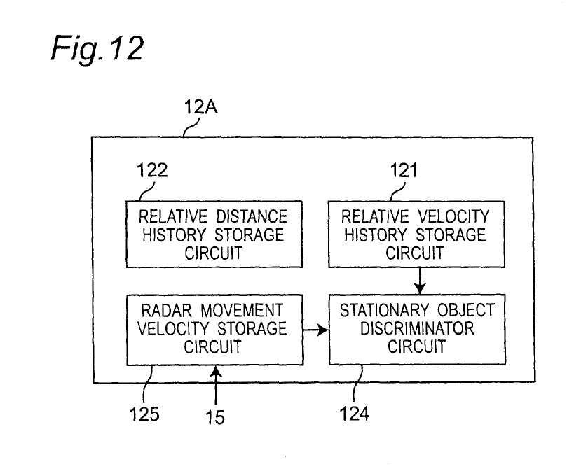

FIG. 12 is a block diagram showing configurations of the movement prediction circuit 12A of the radar apparatus 100A of FIG. 11. As compared with the movement prediction circuit 12 of FIG. 10 of the second embodiment, the movement prediction circuit 12A of FIG. 12 is characterized in that a relative velocity history storage circuit 121A is provided in place of the relative velocity history storage circuit 121, and a stationary object discriminator circuit 124 and a radar movement velocity storage circuit 125 are further provided.

Referring to FIG. 12, the radar movement velocity storage circuit 125 stores movement velocity data of the radar apparatus 100A from the radar movement velocity detector circuit 15. In addition, the stationary object discriminator circuit 124 compares the movement velocity of the radar apparatus 100A stored in the radar movement velocity storage circuit 125 with the relative velocity of the obstacle with respect to the radar apparatus 100A stored in the relative velocity history storage circuit 121, and judges whether or not the obstacle is a stationary object from the comparison result.

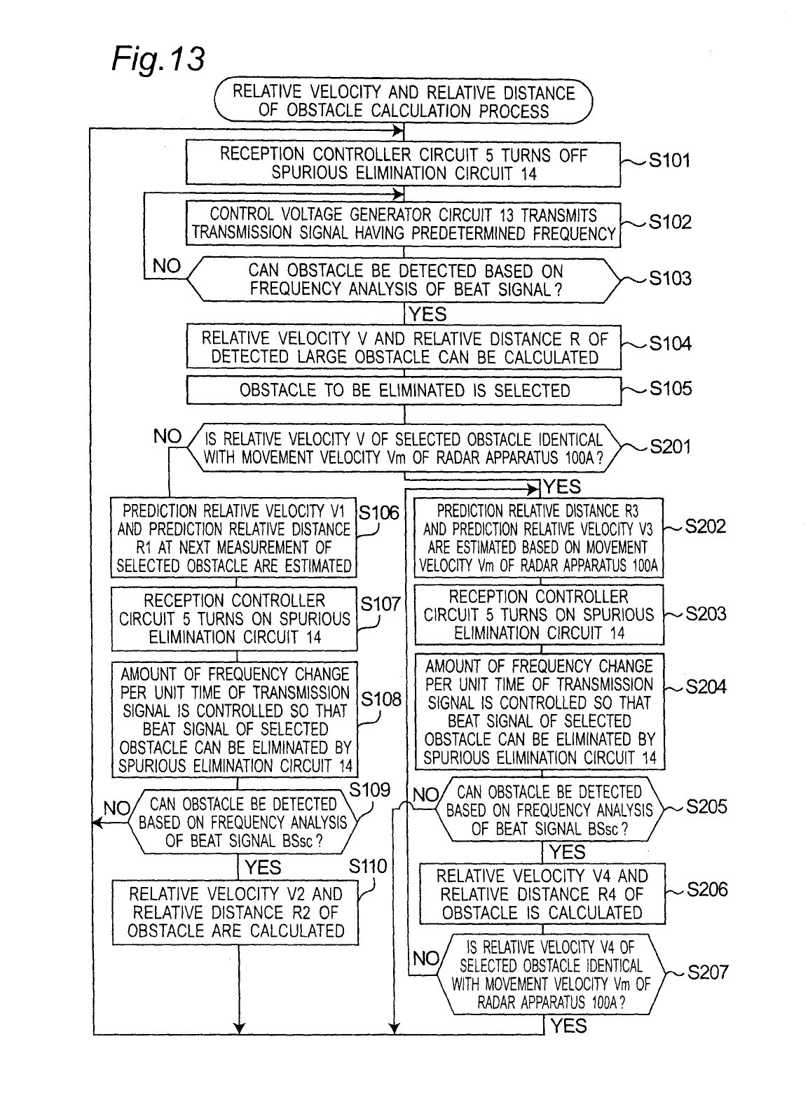

FIG. 13 is a flow chart showing a relative velocity and a relative distance of obstacle calculation process executed by the radar apparatus 100A of FIG. 11. As compared with the flow chart of FIG. 2 of the first embodiment, the flow chart of FIG. 13 is characterized in that a step S201 to judge whether or not the selected obstacle is a stationary object is added to the subsequent stage of step S105 of FIG. 2, and step S202 to step S207 of a processing flow when it is judged to be a stationary object are further added.

The step S201 of FIG. 13 judges whether or not the relative velocity V of the selected obstacle is identical with the movement velocity Vm of the radar apparatus 100A. It is judged that the obstacle is a moving object and the program flow proceeds to step S106 when they are not identical or it is judged that the obstacle is a stationary object and the program flow moves to step S202 when they are identical. Next, in step S202, a prediction relative distance R3 and a prediction relative velocity V3 of the obstacle are estimated on the basis of the movement velocity Vm of the radar apparatus 100A. Next, the spurious elimination circuit 14 is turned on in step S203, and the transmission signal TS is controlled so that the beat signal of the selected obstacle is eliminated (step S204) as in step S108, and the presence or absence of the obstacle is detected from the beat signal BSsc in step S205. When no obstacle is detected, the program flow returns to step S101. When an obstacle is detected, the relative velocity V4 and the relative distance R4 of the newly detected obstacle are calculated in step S206, and it is judged whether or not the relative velocity V4 of the obstacle and the movement velocity Vm of the radar apparatus 100A are identical in step S207 to judge that the newly detected obstacle is a stationary object or a moving object. If it is a moving object, the program flow returns to step S202 to predict the relative distance and the relative velocity of a large stationary object from the movement velocity Vm of the radar apparatus 100A. If it is a stationary object, the program flow returns to step S101.

According to the radar apparatus 100A of the above embodiment, it is possible to further judge whether or not the selected obstacle is a stationary object or a moving object as compared with the radar apparatus 100 of the first embodiment. Therefore, the moving object, of which the relative distance of the obstacle with respect to the radar apparatus 100A easily changes and has a high risk of collision, can be measured while removing the influence of the stationary object, and the risk of collision of the radar apparatus 100A with the obstacle can be more rapidly detected.

### INDUSTRIAL APPLICABILITY

As described above, according to the radar apparatus of the present invention, the transmission signal TS is controlled so that the beat signal of a large obstacle can be eliminated at next measurement, and therefore, it becomes possible to calculate the relative distance and the relative velocity of a small obstacle closing the large obstacle with a low processing load.

### REFERENCE SIGNS LIST

100, 100A Radar apparatus,
1 Oscillator,
2 Transmission antenna,
3 Receiving antenna,
4 Mixer,
5 Reception controller circuit,
6 Switching circuit,
7 Frequency analyzer circuit
8 Relative velocity calculator circuit,
9 Relative distance calculator circuit,
10 Object detector circuit,
11 Object selection circuit,
12, 12A Movement prediction circuit,
121 Relative velocity history storage circuit,
122 Relative distance history storage circuit,
123 Statistical processing circuit,
13 Control voltage generator circuit,
14 Spurious controller circuit,
15 Radar movement velocity detector circuit,
124 Stationary object discrimination circuit, and
125 Radar movement velocity storage circuit.

1: A radar apparatus comprising a transmitting antenna that radiates a transmission signal to detect an obstacle, and a receiving antenna that receives a reflected wave reflected on the obstacle as a reception signal, the radar apparatus comprising:
an oscillator configured to generate the transmission signal whose frequency linearly rises or falls with respect to time;
a mixer configured to generate a first beat signal of a frequency difference between the transmission signal and the reception signal;
a spurious elimination circuit configured to eliminate a frequency component of a predetermined frequency fc in the first beat signal and output a second beat signal;
a frequency analyzer circuit configured to execute frequency analysis of the first beat signal when an operation of the spurious elimination circuit is turned off, execute frequency analysis of the second beat signal when the operation of the spurious elimination circuit is turned on, and output a frequency analysis result,
an object detector circuit configured to detect presence or absence of an obstacle on the basis of the frequency analysis result and output an obstacle detection signal when there is the obstacle;
a relative velocity and relative distance calculator circuit configured to calculate a relative velocity and a relative distance of the obstacle with respect to the radar apparatus on the basis of the frequency analysis result when the object detector detects the obstacle;
an object selector configured to select an obstacle to be eliminated on the basis of the relative velocity and the relative distance;
a movement prediction circuit configured to estimate a relative velocity and a relative distance of a selected obstacle with respect to the radar apparatus at next measurement; and
a control voltage generator configured to control the transmission signal so that the beat signal of the selected obstacle is eliminated by the spurious elimination circuit at next measurement on the basis of the estimated relative velocity and relative distance,
a reception controller circuit configured to turn on or off the spurious elimination circuit on the basis of a result of the selected obstacle by the object selector circuit,
wherein the reception controller circuit turns on the spurious elimination circuit when receiving an obstacle detection signal from the object detector circuit.

2: The radar apparatus as claimed in claim 1,
wherein the control voltage generator circuit controls an amount of frequency change Δfc per unit time and a transmission duration time so that a frequency of the beat signal of the selected obstacle becomes the predetermined frequency fc.

3: The radar apparatus as claimed in claim 2,
wherein the amount of frequency change Δfc is calculated by the following equation:
$$Δ fc = \frac{{cf}_{c} \pm 2 V 1 {f}_{1}}{2 R 1}$$
where C is the velocity of light, V1 is the relative velocity of the obstacle with respect to the radar apparatus at next measurement, R1 is the relative distance of the obstacle with respect to the radar apparatus at next measurement of the selected obstacle, and f₁ is a center frequency of the transmission signal, and
wherein the transmission duration time is equal to or larger than (2×R1/C).

4: The radar apparatus as claimed in claim 1,
wherein the movement prediction circuit comprises a relative velocity history storage circuit configured to store the relative velocity, a relative distance storage history circuit configured to store the relative distance, and a statistical processing circuit configured to predict a movement by using past histories.

5: The radar apparatus as claimed in claim 4,
wherein the statistical processing circuit includes a Kalman filter.

6: The radar apparatus as claimed in claim 1, further comprising:
a circuit configured to detect a movement velocity of the radar apparatus; and
a stationary object discriminator circuit configured to compare the relative velocity of the obstacle with the movement velocity of the radar apparatus, and to judge whether or not the obstacle is a stationary object based on a comparison result.

7: The radar apparatus as claimed in claim 6, further comprising a storage portion configured to store the movement velocity of the radar apparatus.
